(19) United States
(12) Patent Application Publication
(10) Pub. No.: US 2018/0174108 A1
(43) Pub. Date: Jun. 21, 2018

(54) METHOD, SYSTEM AND NON-TRANSITORY COMPUTER-READABLE RECORDING MEDIUM FOR PROVIDING PREDICTIONS ON CALENDAR

(71) Applicant: Konolabs, Inc., Seoul (KR)

(72) Inventors: Jae Woo Kang, Seoul (KR); Dong Hyeon Kim, Yongin-si (KR); Jin Hyuk Lee, Seongnam-si (KR); Jae Hoon Choi, Seoul (KR)

(73) Assignee: Konolabs, Inc., Seoul (KR)

(21) Appl. No.: 15/846,575

(22) Filed: Dec. 19, 2017

(30) Foreign Application Priority Data
Dec. 19, 2016 (KR) 10-2016-0173483

(51) Int. Cl. G06Q 10/10; G06Q 10/04; G06N 7/00; G06F 15/18

(52) U.S. Cl. CPC G06Q 10/1093; G06F 15/18; G06N 7/005; G06Q 10/04

(57) ABSTRACT

A method for providing a prediction, includes generating first prediction data on a start time of a new event to be registered in a calendar of a target user, by sequentially learning calendar data including information on a start time of at least one event existing in a calendar of at least one user, in order of time at which the at least one event is registered in the calendar of the at least one user, generating second prediction data on the start time of the new event with reference to text information on the new event, and generating third prediction data on the start time of the new event with reference to preference information of the target user; and predicting the start time of the new event by calculating a likelihood of the start time of the new event with reference to the first, second, and third prediction data.

### CROSS-REFERENCE TO RELATED APPLICATIONS

This application claims priority to Korean Patent Application No. 10-2016-0173483 filed on Dec. 19, 2016, the entire contents of which are hereby incorporated by reference.

### FIELD OF THE INVENTION

The present invention relates to a method, system, and non-transitory computer-readable recording medium for providing predictions on a calendar.

### BACKGROUND

Recently, the developments in technologies related to the Internet, cloud computing, and mobile devices have introduced a variety of cloud-based calendar management services such as Google Calendar, Microsoft Outlook, and iCloud.

The conventional calendar management services provide a function that allows a user to manage his/her calendar in a unified manner, regardless of locations, times, devices, and the like. However, they still provide a basic function of simply creating, modifying, deleting, or sharing an event according to an explicit and specific input of the user.

Recently, some conventional techniques for analyzing life patterns or work patterns of a user to provide predictions on the user's calendar have been introduced. However, the conventional techniques are still limited in that the low prediction reliability or accuracy thereof makes it difficult to render substantial assistance to the user.

### SUMMARY OF THE INVENTION

One object of the present invention is to solve all the above-described problems in the prior art.

Another object of the invention is to predict a start time suitable for a new event that a user intends to newly register in the user's calendar, by generating first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user, generating second prediction data on the start time of the new event with reference to text information on the new event, and generating third prediction data on the start time of the new event with reference to preference information of the target user on the calendar; and predicting the start time of the new event by calculating a likelihood of the start time of the new event being included in at least one time slot constituting the calendar of the target user, with reference to the first, second, and third prediction data.

The representative configurations of the invention to achieve the above objects are described below.

According to one aspect of the invention, there is provided a method for providing a prediction on a calendar, comprising the steps of: generating first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user, generating second prediction data on the start time of the new event with reference to text information on the new event, and generating third prediction data on the start time of the new event with reference to preference information of the target user on the calendar; and predicting the start time of the new event by calculating a likelihood of the start time of the new event being included in at least one time slot constituting the calendar of the target user, with reference to the first, second, and third prediction data.

According to another aspect of the invention, there is provided a system for providing a prediction on a calendar, comprising: a calendar data analysis unit configured to generate first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user; a text information analysis unit configured to generate second prediction data on the start time of the new event with reference to text information on the new event; a preference information analysis unit configured to generate third prediction data on the start time of the new event with reference to preference information of the target user on the calendar; and a prediction provision unit configured to predict the start time of the new event by calculating a likelihood of the start time of the new event being included in at least one time slot constituting the calendar of the target user, with reference to the first, second, and third prediction data.

In addition, there are further provided other methods and systems to implement the invention, as well as non-transitory computer-readable recording media having stored thereon computer programs for executing the methods.

According to the invention, it is possible to predict a start time suitable for a new event that a user intends to newly register in the user's calendar.

According to the invention, it is possible to consider not only event registration patterns occurring in a user's calendar, but also text information on a new event that the user intends to newly register and personalized preference information of the user on time slots, thereby predicting a time at which the new event is suitably implemented or likely to be implemented.

According to the invention, it is possible to train a neural network by comprehensively utilizing calendar data on event registration patterns, text information on titles of events, and preference information on time slots, so that a start time of a new event may be predicted sufficiently accurately even when the amount of data used for the neural network training is relatively small.

According to the invention, it is possible to consider not only personalized calendar data on event registration patterns of a user, but also personalized preference information of the user on time slots, so that an integrated prediction model equally applicable to all users may be constructed without having to separately provide a personalized prediction model for each user.

According to the invention, it is possible to accurately train a prediction model using sequential properties of calendar data.

According to invention, it is possible to learn extensive calendar data including information on time slot selection behaviors, patterns, or tendencies observed from calendars of numerous users, thereby accurately predicting a time slot expected to be actually determined as a start time of a new event when a person newly register the new event in his/her calendar.

### BRIEF DESCRIPTION OF THE DRAWINGS

FIG. 1 schematically shows the configuration of an entire system for providing predictions on a calendar according to one embodiment of the invention.

FIG. 2 illustratively shows the internal configuration of a calendar management system according to one embodiment of the invention.

FIG. 3 illustratively shows how to predict and provide a start time of a new event to be newly registered in a calendar of a user according to one embodiment of the invention.

FIG. 4 illustratively shows how to predict a time slot suitable for a start time of a new event to be newly registered in a calendar of a user according to one embodiment of the invention.

FIG. 5 conceptually illustrates how to predict a time slot suitable for a start time of a new event by respectively generating first, second, and third prediction data and collectively using the prediction data according to one embodiment of the invention.

FIG. 6 illustratively shows a language model including information on relationships between texts and time slots according to one embodiment of the invention.

FIG. 7 illustratively shows results of tests for actually predicting a time slot suitable for a start time of a new event to be newly registered in a calendar of a user according to one embodiment of the invention.

FIG. 8 illustratively shows results of tests for actually predicting a time slot suitable for a start time of a new event to be newly registered in a calendar of a user according to one embodiment of the invention.

FIG. 9A illustratively shows results of tests for actually predicting a time slot suitable for a start time of a new event to be newly registered in a calendar of a user according to one embodiment of the invention.

FIG. 9B illustratively shows results of tests for actually predicting a time slot suitable for a start time of a new event to be newly registered in a calendar of a user according to one embodiment of the invention.

FIG. 10A illustratively shows results of tests for actually predicting a time slot suitable for a start time of a new event to be newly registered in a calendar of a user according to one embodiment of the invention.

FIG. 10B illustratively shows results of tests for actually predicting a time slot suitable for a start time of a new event to be newly registered in a calendar of a user according to one embodiment of the invention.

FIG. 11A illustratively shows results of tests for actually predicting a time slot suitable for a start time of a new event to be newly registered in a calendar of a user according to one embodiment of the invention.

FIG. 11B illustratively shows results of tests for actually predicting a time slot suitable for a start time of a new event to be newly registered in a calendar of a user according to one embodiment of the invention.

FIG. 12A illustratively shows results of tests for actually predicting a time slot suitable for a start time of a new event to be newly registered in a calendar of a user according to one embodiment of the invention.

FIG. 12B illustratively shows results of tests for actually predicting a time slot suitable for a start time of a new event to be newly registered in a calendar of a user according to one embodiment of the invention.

FIG. 13A illustratively shows results of tests for actually predicting a time slot suitable for a start time of a new event to be newly registered in a calendar of a user according to one embodiment of the invention.

FIG. 13B illustratively shows results of tests for actually predicting a time slot suitable for a start time of a new event to be newly registered in a calendar of a user according to one embodiment of the invention.

FIG. 14A illustratively shows results of tests for actually predicting a time slot suitable for a start time of a new event to be newly registered in a calendar of a user according to one embodiment of the invention.

FIG. 14B illustratively shows results of tests for actually predicting a time slot suitable for a start time of a new event to be newly registered in a calendar of a user according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of the Entire System

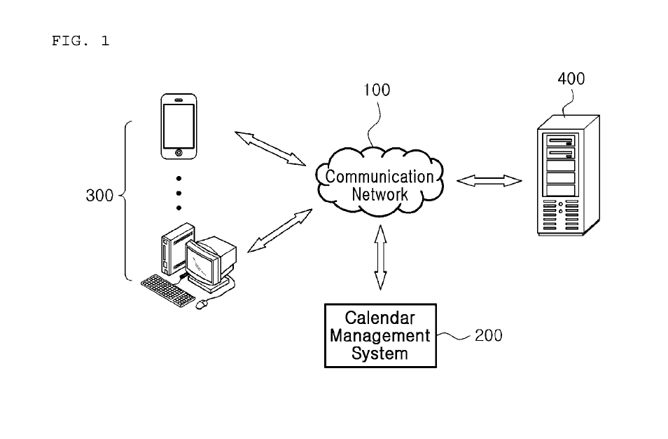

FIG. 1 schematically shows the configuration of an entire system for providing predictions on a calendar according to one embodiment of the invention.

As shown in FIG. 1, the entire system according to one embodiment of the invention may comprise a communication network 100, a calendar management system 200, a user device 300, and an external server 400.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the calendar management system 200 according to one embodiment of the invention may function to predict a start time suitable for a new event that a user intends to newly register in the user's calendar, by generating first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user, generating second prediction data on the start time of the new event with reference to text information on the new event, and generating third prediction data on the start time of the new event with reference to preference information of the target user on the calendar; and predicting the start time of the new event by calculating a likelihood of the start time of the new event being included in at least one time slot constituting the calendar of the target user, with reference to the first, second, and third prediction data.

The configuration and function of the calendar management system 200 according to the invention will be discussed in more detail below.

Next, according to one embodiment of the invention, the user device 300 is digital equipment that may function to allow a user to connect to and then communicate with the calendar management system 200 or the external server 400, and any type of digital equipment having a memory means and a microprocessor for computing capabilities, such as a smart phone, a tablet, a desktop computer, a notebook computer, a workstation, a personal digital assistant (PDA), a web pad, and a mobile phone, may be adopted as the user device 300 according to the invention.

Particularly, the user device 300 may include an application (not shown) to assist a user to receive calendar-related services from the calendar management system 200. The application may be downloaded from the calendar management system 200 or the external server 400.

Meanwhile, according to one embodiment of the invention, the external server 400 may function to provide the calendar management system 200 or the user device 300 with information on calendar data, information on relationships between texts and time slots, or preference information of the user on time slots. Specifically, the external server 400 according to one embodiment of the invention may be a server operated by an entity providing an online calendar service, or providing a social network service (SNS) such as Twitter, Facebook, and Instagram from which various context information or preference information on the user may be collected.

Configuration of the Calendar Management System

Hereinafter, the internal configuration of the calendar management system crucial for implementing the invention and the functions of the respective components thereof will be discussed.

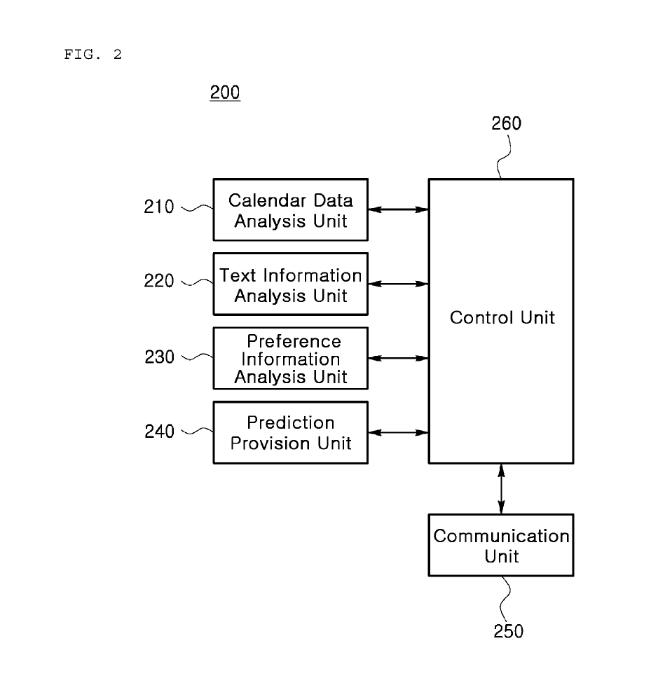

FIG. 2 illustratively shows the internal configuration of the calendar management system according to one embodiment of the invention.

Referring to FIG. 2, the calendar management system 200 according to one embodiment of the invention may comprise a calendar data analysis unit 210, a text information analysis unit 220, a preference information analysis unit 230, a prediction provision unit 240, a communication unit 250, and a control unit 260. According to one embodiment of the invention, at least some of the calendar data analysis unit 210, the text information analysis unit 220, the preference information analysis unit 230, the prediction provision unit 240, the communication unit 250, and the control unit 260 may be program modules to communicate with an external system (not shown). The program modules may be included in the calendar management system 200 in the form of operating systems, application program modules, and other program modules, while they may be physically stored in a variety of commonly known storage devices. Further, the program modules may also be stored in a remote storage device that may communicate with the calendar management system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the calendar data analysis unit 210 may function to generate first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user (so-called “slot embedding”). Here, according to one embodiment of the invention, the first prediction data may include information on a likelihood (i.e., probability) that at least one time slot constituting the calendar of the target user will include the start time of the new event to be newly registered in the calendar of the target user.

Here, according to one embodiment of the invention, at least one event registered in a calendar of a user may be grouped into event groups by predetermined time periods (e.g., weeks, months, etc.) on the basis of a start time thereof, and a plurality of events included in an event group may be sorted in order of registered times thereof. Further, according to one embodiment of the invention, the aforementioned learning for generating the first prediction data may be performed for each event group, and thus the calendar data analysis unit 210 may sequentially learn calendar data including information on start times of events included in a specific event group.

Further, according to one embodiment of the invention, the calendar data used in the learning performed to generate the first prediction data may be acquired from calendars of a plurality of users, and vast amounts of calendar data acquired from calendars of hundreds or thousands of users may be used in the learning as necessary, in order to increase the accuracy of the prediction.

For example, it may be assumed that vast amounts of calendar data on numerous events whose start times are included in a time period from the first week to the last week of the year 2016 are collected from calendars of n users. In this case, according to one embodiment of the invention, the collected calendar data may be grouped by users or weeks, and learning for the calendar data may be performed for each group. Further, according to one embodiment of the invention, a result of the learning for the calendar data collected from the calendars of the n users may not only be used in predicting a start time of a new event to be newly registered in a calendar of a user belonging to the n users, but may also be extensively used in predicting a start time of a new event to be newly registered in a calendar of another user not belonging to the n users.

Specifically, according to one embodiment of the invention, the calendar data analysis unit 210 may generate the first prediction data on the start time of the new event to be newly registered in the calendar of the target user, by sequentially learning j−1^{th} calendar data, which include information on a start time of at least one event existing in a calendar of a m^{th} user immediately after a j−1^{th} event (i.e., an event that is registered in the calendar of the user for the j−1^{th} time) is registered in the calendar of the m^{th} user, and j^{th} calendar data, which include information on a start time of at least one event existing in the calendar of the m^{th} user immediately after a j^{th} event (i.e., an event that is registered in the calendar of the user for the j^{th} time) is registered in the calendar of the m^{th} user. Generally, users tend to first utilize their preferred time slots when registering (i.e., creating) events in their calendars. Thus, according to one embodiment of the invention, it is possible to predict a suitable time slot in which the target user will place the start time of the new event to be newly registered in the calendar of the target user, by sequentially learning start times of events registered in calendars of various users, in order of registered times thereof.

More specifically, according to one embodiment of the invention, the calendar data analysis unit 210 may sequentially learn the calendar data using a recurrent neural network algorithm. For example, the calendar data analysis unit 210 according to one embodiment of the invention may sequentially learn the calendar data using a RNN-LSTM (Recurrent Neural Network-Long Short Term Memory) based learning model.

Further, according to one embodiment of the invention, the calendar data may be specified by a calendar map defined on the basis of at least one time slot constituting the calendar of the at least one user.

Next, according to one embodiment of the invention, the text information analysis unit 220 may function to generate second prediction data on the start time of the new event to be newly registered in the calendar of the target user, with reference to text information on the new event (so-called “word embedding”). Here, according to one embodiment of the invention, the text information on the new event may include a text constituting a title of the new event, a text constituting a memo created for the new event, a text constituting a name of another user attending the new event, and a text indicating a location or time at which the new event is held. Further, according to one embodiment of the invention, the second prediction data may include information on a likelihood (i.e., probability) that at least one time slot constituting the calendar of the target user will include the start time of the new event to be newly registered in the calendar of the target user.

Specifically, according to one embodiment of the invention, the text information analysis unit 220 may generate the second prediction data on the start time of the new event, by using an algorithm for learning a relationship between time and a text constituting the title of the new event, or using a model including information on the relationship between time and the text.

Next, according to one embodiment of the invention, the preference information analysis unit 230 may function to generate third prediction data on the start time of the new event to be newly registered in the calendar of the target user, with reference to preference information of the target user on the calendar (so-called “user embedding”). Here, according to one embodiment of the invention, the third prediction data may include information on a likelihood (i.e., probability) that at least one time slot constituting the calendar of the target user will include the start time of the new event to be newly registered in the calendar of the target user. Further, according to one embodiment of the invention, the preference information of the user may be dynamically updated according to an aspect or tendency in how the user uses the calendar.

Specifically, according to one embodiment of the invention, the preference information analysis unit 230 may generate the third prediction data on the start time of the new event to be newly registered in the calendar of the target user, by predicting a suitable time slot in which the start time of the new event will be included, with reference to the preference information of the target user on at least one time slot constituting the calendar of the target user. More specifically, according to one embodiment of the invention, the preference information of the target user on at least one time slot constituting the calendar of the target user may be derived as a result of sequentially learning calendar data including information on start times of events existing in the calendar of the target user, in order of times at which the events are registered in the calendar of the target user.

Meanwhile, according to one embodiment of the invention, the aforementioned calendar data, text information, and preference information may be, but not necessarily limited to, data or information generated and managed in the calendar service provided by the calendar management system 200 according to the invention. It is noted that at least a part of the calendar data, text information, and preference information may also be collected from the external server 400 external to the calendar management system 200 according to the invention.

Next, according to one embodiment of the invention, the prediction provision unit 240 may function to predict the start time of the new event to be newly registered in the calendar of the target user, with reference to the first, second, and third prediction data generated as above. Further, according to one embodiment of the invention, the prediction provision unit 240 may recommend the target user at least one time slot that is predicted to be likely to include the start time of the new event.

Specifically, according to one embodiment of the invention, the prediction provision unit 240 may determine n time slots that are most likely to include the start time of the new event newly registered in the calendar of the target user, by calculating a likelihood of the start time of the new event being included in at least one time slot constituting the calendar of the target user, and may recommend the determined n time slots to the target user as a result of the prediction.

More specifically, according to one embodiment of the invention, each of the first, second, and third prediction data on the start time of the new event may be specified as a vector directly or indirectly representing a probability of the start time of the new event being included in at least one time slot constituting the calendar of the target user. The prediction provision unit 240 according to one embodiment of the invention may predict a time slot that is likely to include the start time of the new event, with reference to an output vector generated as a result of composition of a vector specifying the first prediction data, a vector specifying the second prediction data, and a vector specifying the third prediction data.

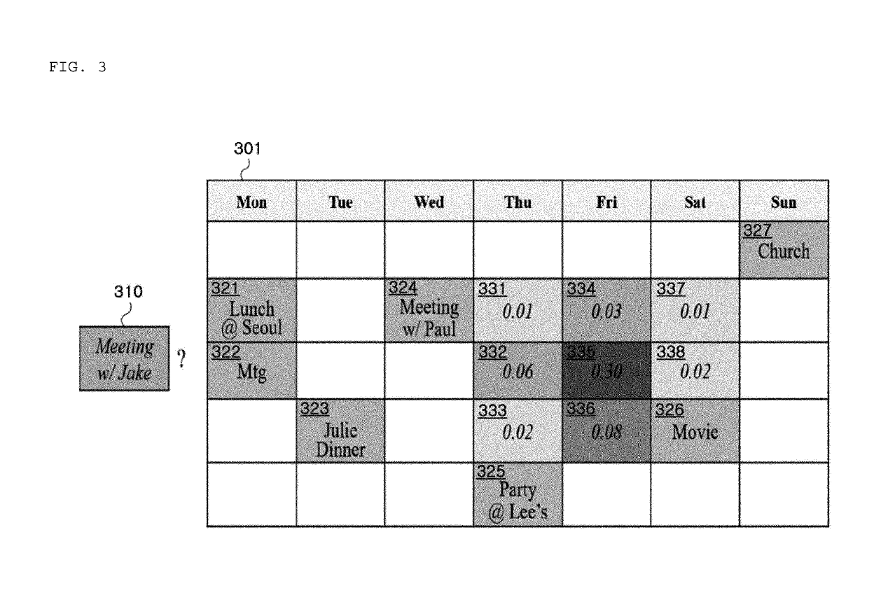

FIG. 3 illustratively shows how to predict and provide a start time of a new event to be newly registered in a calendar of a user according to one embodiment of the invention.

Referring to FIG. 3, it may be assumed that a user A newly registers a new event 310, “Meeting w/Jake” in a calendar 301 of the user A.

In this case, the calendar management system 200 according to one embodiment of the invention may generate first prediction data on a start time of the new event 310 to be newly registered in the calendar of the user A, by sequentially learning calendar data including information on start times of a plurality of other events 321 to 327 already registered (i.e., already existing) in calendars of a plurality of users including or not including the user A, in order of times at which the plurality of other events 321 to 327 are registered in the calendars of the plurality of users. The calendar management system 200 according to one embodiment of the invention may generate second prediction data on the start time of the new event 310 with reference to information on a text constituting a title of the new event 310 (i.e., “Meeting w/Jake”), and may generate third prediction data on the start time of the new event 310 with reference to preference information of the user A on time slots constituting the calendar of the user A. Further, the calendar management system 200 according to one embodiment of the invention may calculate a likelihood of the start time of the new event 310 being included in each of a plurality of time slots 331 to 338 constituting the calendar 301 of the user A, with reference to all of the first, second, and third prediction data generated as above, and may determine the time slot 335 with the highest likelihood of 0.30 as a time slot suitable for the start time of the new event (or a time slot predicted to include the start time of the new event).

Meanwhile, the communication unit 250 according to one embodiment of the invention may function to enable the calendar management system 200 to communicate with an external device such as the user device 300.

Lastly, the control unit 260 according to one embodiment of the invention may function to control data flow among the calendar data analysis unit 210, the text information analysis unit 220, the preference information analysis unit 230, the prediction provision unit 240, and the communication unit 250. That is, the control unit 260 may control inbound data flow or data flow among the respective components of the calendar management system 200, such that the calendar data analysis unit 210, the text information analysis unit 220, the preference information analysis unit 230, the prediction provision unit 240, and the communication unit 250 may carry out their particular functions, respectively.

### Embodiments

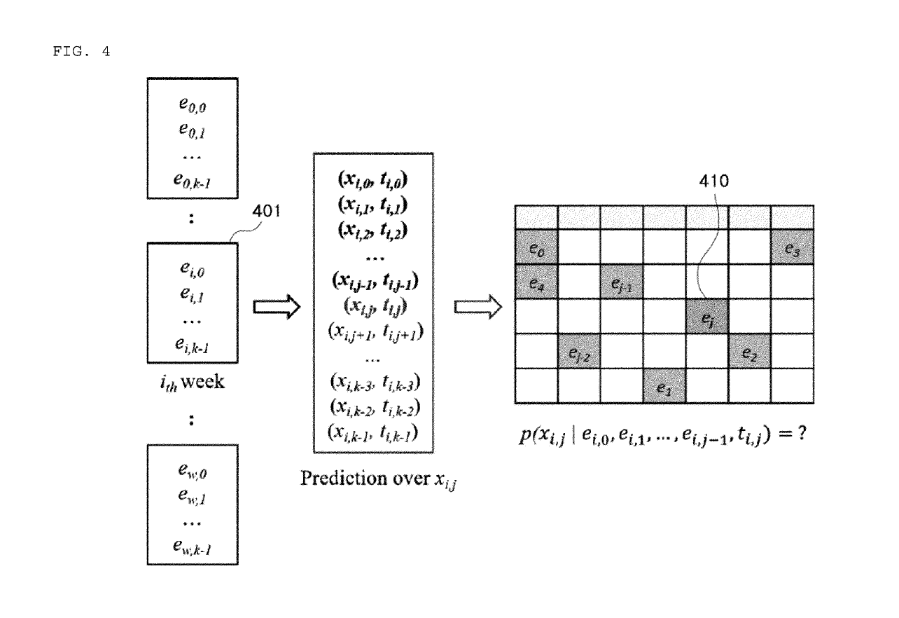

Hereinafter, the configuration for predicting a start time of a new event to be newly registered in a calendar of a user according to one embodiment of the invention will be discussed in detail with reference to FIGS. 4 to 14B.

According to one embodiment of the invention, an event registered in a calendar of a user may have three attributes, i.e., a title, a start time, and a registered time. Here, according to one embodiment of the invention, the title of the event may indicate information on a text that is arbitrarily inputted to denote a purpose, type, location, attendant and the like of the event, while the start time of the event may indicate a time at which the event is scheduled to start, and the registered time of the event may indicate a time at which the event is registered (i.e., created) in the calendar of the user. Particularly, according to one embodiment of the invention, since users generally tend to put events first in their preferred time slots, the registered time of the event may be utilized as an important basis in learning preference of the user on time slots.

Further, according to one embodiment of the invention, a plurality of events registered in the calendar of the user may be grouped by predetermined time periods (e.g., weeks, months, etc.) on the basis of start times thereof, and the plurality of events included in the event groups may be sorted in order of registered times thereof.

Furthermore, according to one embodiment of the invention, k events whose start times are included in an i^{th} time period in a calendar of a user A (e.g., the i^{th} week of the year 2016) may be grouped into one event group Eᵢ, which may be expressed as Eq.1 below.

Eᵢ=[e_{i,0},e_{i,1}, . . . ,e_{i,k-1}] (Eq. 1)

In Eq. 1, the k events may be sorted in order of registered times thereof (j; j=0 to k−1), and each of the k events e_{i,j} may be expressed as Eq. 2 below.

e_{i,j}=(x_{i,j},t_{i,j}) (Eq. 2)

In Eq. 2, x_{i,j} may indicate a time slot that includes the start time of the event registered for the j+1^{th} time in the event group Eᵢ, and t_{i,j} may indicate the title of the event registered for the j+1^{th} time in the event group Eᵢ.

Further, the calendar management system 200 according to one embodiment of the invention may find out the most suitable start time (i.e., time slot) of the new event to be newly registered in the calendar of the target user in a target time period (i.e., a time period for which the scheduling is performed or in which the start time of the new event is to be included), with reference to a result of learning for calendar data that may be acquired from calendars of various users, as well as information on texts constituting titles of events, and preference information of the target user on time slots.

Specifically, when j events are already registered in a target time period (i.e., a time period for which the scheduling is performed or in which the start time of the new event is to be included), the calendar data analysis unit 210 according to one embodiment of the invention may predict a time slot suitable for the start time of the j+1^{th} event e_{i,j} (i.e., the new event) to be newly registered in the time period, with reference to a result of learning for calendar data acquired from calendars of various users. Further, the text information analysis unit 220 according to one embodiment of the invention may predict a time slot suitable for the start time of the j+1^{th} event e_{i,}) to be newly registered in a target time period (i.e., a time period for which the scheduling is performed or in which the start time of the new event is to be included), with reference to the title t_{i,j} of the j+1^{th} event e_{i,j} Furthermore, the preference information analysis unit 230 according to one embodiment of the invention may predict a time slot suitable for the start time of the j+1^{th} event e_{i,j}, with reference to preference information of the target user on time slots included in a target time period (i.e., a time period for which the scheduling is performed or in which the start time of the new event is to be included).

More specifically, according to one embodiment of the invention, a conditional probability p representing a likelihood of the start time of the j+1^{th} event e_{i,j} to be newly registered being included in a time slot x_{i,j} belonging to a target time period (i.e., a time period for which the scheduling is performed or in which the start time of the new event is to be included) may be expressed as Eq. 3 below.

p(x_{i,j}|e_{i,0},e_{i,1}, . . . ,e_{i,j-1},t_{i,j}) (Eq. 3)

In Eq. 3, t_{i,j} may indicate the title of the j+1^{th} event to be newly registered.

FIG. 4 illustratively shows how to predict a time slot suitable for a start time of a new event to be newly registered in a calendar of a user according to one embodiment of the invention.

Referring to FIG. 4, in predicting a time slot suitable for a start time of a j+1^{th} event (e_{i,i}=(x_{i,j}, t_{i,j})) to be newly registered when j events are registered in an i^{th} week 401 in FIG. 4, a time slot 410 having the highest conditional probability p according to Eq. 3 may be predicted to be the most suitable time slot for the start time of the j+1^{th} event.

Hereinafter, a process of predicting at least one time slot having a high conditional probability according to Eq. 3, among time slots constituting a target time period (i.e., a time period for which the scheduling is performed or in which the start time of the new event is to be included), will be discussed in more detail.

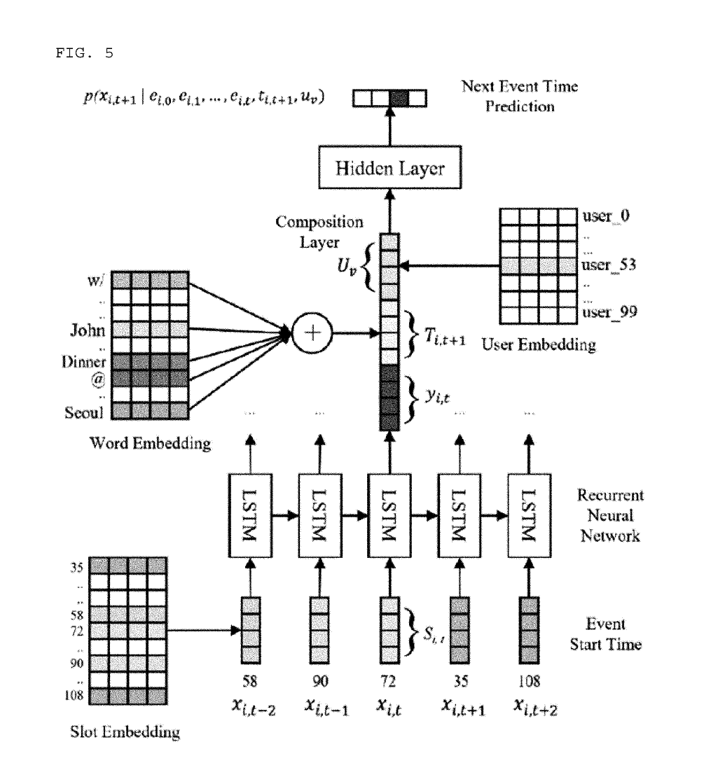

FIG. 5 conceptually illustrates how to predict a time slot suitable for a start time of a new event by respectively generating first, second, and third prediction data and collectively using the above prediction data according to one embodiment of the invention.

Referring to FIG. 5, the calendar management system 200 according to one embodiment of the invention may generate first prediction data on a start time of a new event to be newly registered in a calendar of a target user (i.e., “Slot Embedding” in FIG. 5), by referring to a result of learning for various calendar data acquired from calendars of numerous users using a RNN-LSTM based learning model (i.e., a LSTM or recurrent neural network in FIG. 5), and sequentially learning calendar data including information on start times of events existing in the calendar of the target user (e.g., Slots 58, 90, 72, 35, 108, etc. in FIG. 5) each time an event is registered in a target time period (i.e., a time period for which the scheduling is performed or in which the start time of the new event is to be included) in the calendar of the target user (i.e., each time an event registration state of the calendar of the target user is changed).

For example, when a t^{th} event e_{i,t} (t=1 to k) is registered in an i^{th} week in the calendar of the target user, information on a start time x_{i,t} of the t^{th} event may be inputted to the RNN-LSTM based learning model. As the RNN-LSTM based learning model performs learning on the basis of the above input, first prediction data y_{i,t} on a start time of a new event e_{i,t+1} to be registered in the i^{th} week for the t+1^{th} time may be outputted, and the first prediction data y_{i,t} may be specified as a vector.

Referring further to FIG. 5, the calendar management system 200 according to one embodiment of the invention may generate second prediction data on the start time of the new event to be newly registered in the calendar of the target user (i.e., “Word Embedding” in FIG. 5), by referring to a title of the new event to be newly registered in the calendar of the target user (e.g., “w/”, “John”, “Dinner”, “@”, “Seoul”, etc. in FIG. 5), and a language model (which is a kind of database) including information on relationships between time slots constituting the calendar and various texts that may constitute titles of events registered in the calendar.

For example, second prediction data T_{i,t+1} on the start time of the new event e_{i,t+1} to be registered in the i^{th} week in the calendar of the target user for the t+1^{th} time may be generated on the basis of a title t_{i,t+1} of the new event e_{i,t+1} to be registered in the i^{th} week for the t+1^{th} time, and the language model including information on relationships between the time slots and the texts, and the second prediction data T_{i,t+1} may be specified as a vector.

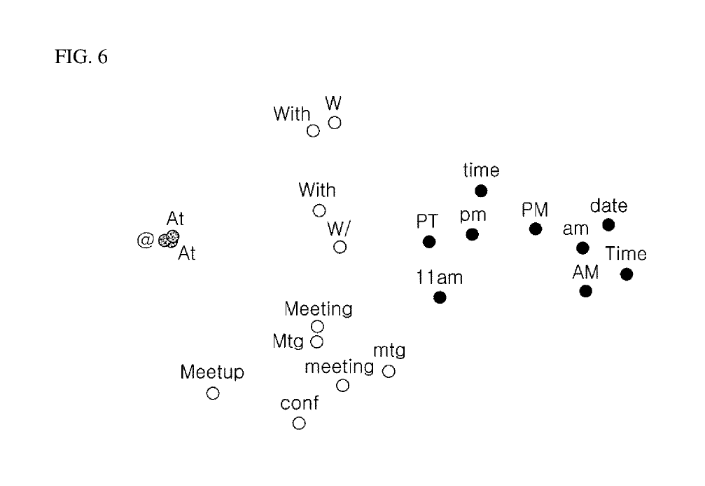

FIG. 6 illustratively shows a language model including information on relationships between texts and time slots according to one embodiment of the invention.

Referring to FIG. 6, as a result of learning for data on texts constituting titles of various events registered in calendars of numerous users and time slots corresponding (or related) thereto, a language model including information on relationships between the texts and the time slots may be generated (which is a so-called Cal2Vec model). Particularly, according to one embodiment of the invention, the relationships between the time slots and abbreviations (e.g., “conf”, “mtg”, etc.) or symbols (e.g., “w/”, @”, etc.), which are not usually used in formal documents or conversations but commonly used in titles of events, may also be derived.

Referring further to FIG. 5, the calendar management system 200 according to one embodiment of the invention may generate third prediction data on the start time of the new event to be newly registered in the calendar of the target user (i.e., “User Embedding” in FIG. 5), with reference to preference information of the target user (e.g., user_0, user_53, or user_99 in FIG. 5) on time slots observed in or out of the calendar service.

For example, third prediction data Uᵥ on the start time x_{i,t} of the new event e_{i,t+1} to be registered in the i^{th} week for the t+1^{th} time may be generated on the basis of preference information of a user uᵥ who is the target user, and the third prediction data Uᵥ may be specified as a vector.

Referring further to FIG. 5, the calendar management system 200 according to one embodiment of the invention may derive collective prediction data [y_{i,t}, T_{i,t+1}, Uᵥ] (i.e., “Composition Layer” in FIG. 5), which are composition of (or which embed) all of the first prediction data y_{i,t} based on the calendar data, the second prediction data T_{i,t+1} based on the title of the event, and the third prediction data Uᵥ based on the preference information of the target user.

Specifically, according to one embodiment of the invention, various algorithms for normalization or optimization may be applied in combining the first prediction data y_{i,t}, the second prediction data and the third prediction data Uᵥ to derive the collective prediction data (i.e., the output vector).

Referring further to FIG. 5, the calendar management system 200 according to one embodiment of the invention may calculate a conditional probability p representing a likelihood of the start time of the t+1^{th} event e_{i,t+1} to be newly registered being included in a time slot x_{i,j} belonging to the i^{th} time period in the calendar of the user uᵥ who is the target user (i.e., “Next Event Time Prediction” in FIG. 5), on the basis of the collective prediction data derived as above. According to one embodiment of the invention, the conditional probability p may be expressed as Eq. 4 below.

p(x_{i,t+1}|e_{i,0},e_{i,1}, . . . ,e_{i,t},t_{i,t+1},t_{i,j}) (Eq. 4)

Referring further to FIG. 5, the calendar management system 200 according to one embodiment of the invention may recommend the target user n most suitable time slots for the start time of the t+1^{th} event to be newly registered in the i^{th} time period in the calendar of the user uᵥ who is the target user, on the basis of the conditional probability p calculated as above.

### Test Examples

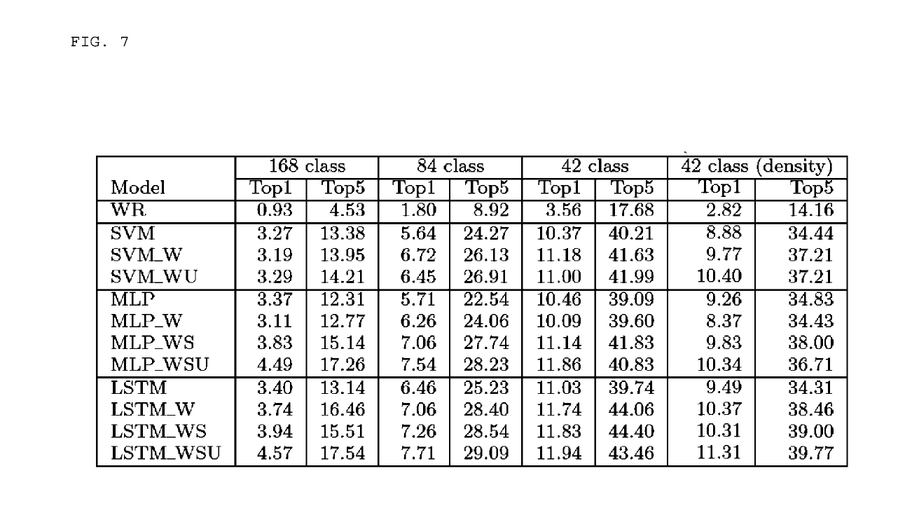

FIGS. 7 to 14B illustratively show results of tests for actually predicting a time slot suitable to include a start time of a new event to be newly registered in a calendar of a user according to one embodiment of the invention.

In the test examples of FIGS. 7 to 14B, calendar data for the period from April 2015 to February 2016 were collected from calendars of 2,312 users using English. In order to increase the validity of the calendar data, data on events automatically created by predefined rules or other applications, events created in calendars shared by two or more users, events with blank or meaningless titles, and all-day events not limited to a particular time slot were excluded.

Further, in the test examples of FIGS. 7 to 14B, the calendar data of 100 users who have 500 or more events registered in the calendars were selected and used among the collected calendar data, and the number of events constituting the selected calendar data was 154,590.

Furthermore, in the test examples of FIGS. 7 to 14B, the time period of one week, which is the criterion for specifying an event group defining the range of learning (i.e., machine learning) or prediction, was divided into time slots of various lengths, in order to enhance the diversity and reliability of the test results. Specifically, in the test examples of FIGS. 7 to 14B, four cases were assumed in which one week is constituted by 168 one-hour long time slots (“168 class” in FIG. 7), by 84 two-hour long time slots (“84 class” in FIG. 7), by 42 four-hour long time slots (“42 class” in FIG. 7), and by 42 four-hour long dense time slots with time periods from 0 to 6 o'clock being excluded (“42 class (density)” in FIG. 7), respectively, and the accuracy of prediction of the start time of the new event was measured for each of the above four cases.

First, referring to FIG. 7, the accuracy of prediction of the event start time using a conventional prediction model such as a WR (Weighted Random) prediction model, a SVP (Support Vector Machine) prediction model, and a MLP (Multi-Layer Perceptron) prediction model may be compared with the accuracy of prediction of the event start time using a LSTM (Long Short Term Memory) prediction model according to the invention (more precisely, a LSTM_WSU (Long Short Term Memory_Word Slot User) prediction model). In FIG. 7, “Top 1” indicates a probability of the start time of the new event being actually included in a top one time slot predicted by the prediction model (i.e., a probability of the one time slot predicted by the prediction model being actually selected as the start time of the new event by the user), and “Top 5” indicates a probability of the start time of the new event being actually included in any one of top five time slots predicted by the prediction model (i.e., a probability of any one of the top five time slots predicted by the prediction model being actually selected as the start time of the new event by the user). That is, it can be said that the prediction accuracy of the prediction model is higher as the probability of “Top 1” or “Top 5” is higher.

Specifically, referring to FIG. 7, when the WR prediction model (WR in FIG. 7) is used, the prediction accuracy is the lowest because context information is not considered in the prediction process. Referring further to FIG. 7, when the SVP or MLP prediction model (SVP or MLP in FIG. 7) is used, the prediction accuracy is higher than when the WR prediction model is used, because information on a time slot S of the event or context information such as a title W of the event and preference information U of the user is further reflected in both of the SVP and MLP prediction models (SVP_W, SVP_WU, MLP_W, MLP_WS, and MLP_WSU in FIG. 7). Referring further to FIG. 7, when the LSTM prediction model according to the invention (LSTM in FIG. 7) is used, the prediction accuracy is higher than when the conventional prediction models are used. Particularly, the prediction accuracy of the LSTM prediction model according to the invention is significantly increased as information on the time slot S of the event, information on the title W of the event, and preference information U of the user are further reflected (LSTM_W, LSTM_WS, and LSTM_WSU in FIG. 7).

Particularly, referring to FIG. 7, when the LSTM prediction model in which the word embedding, slot embedding, and user embedding according to the invention are all applied (LSTM_WSU in FIG. 7) is used, the prediction accuracy is the highest in all of the cases in which one week is constituted by 168 one-hour long time slots (“168 class” in FIG. 7), by 84 two-hour long time slots (“84 class” in FIG. 7), by 42 four-hour long time slots (“42 class” in FIG. 7), and by 42 four-hour long dense time slots with time periods from 0 to 6 o'clock being excluded (“42 class (density)” in FIG. 7), respectively.

Meanwhile, referring to FIG. 7, it can be seen that the prediction accuracy of the case in which one week is constituted by 42 four-hour long dense time slots with time periods from 0 to 6 o'clock being excluded (“42 class (density)” in FIG. 7) is lower than that of the case in which one week is constituted by 42 four-hour long time slots (“42 class” in FIG. 7). Thus, according to one embodiment of the invention, equally divided time slots may be effectively employed in sequentially learning calendar data or making a prediction in consideration of information on titles of events and preference information of users.

Hereinafter, the reason why the prediction model according to the invention can achieve remarkable prediction performance as described above will be discussed in detail.

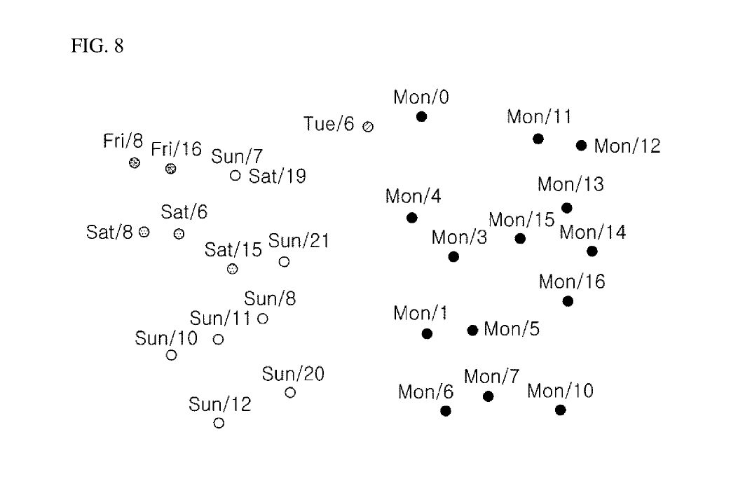

FIG. 8 illustratively shows a significant effect that may be achieved by sequentially learning calendar data including information on start times of events in order of registered times thereof according to one embodiment of the invention.

Referring to FIG. 8, as a result of sequentially learning the calendar data according to the invention, predetermined vector values for the start times and registered times of the events may be assigned to time slots constituting a calendar of a user, and it can be seen that the time slots temporally close to each other tend to have similar vector values. For example, in a two-dimensional plane shown in FIG. 8 based on the vector values, it can be seen that the time slots corresponding to Monday afternoon time periods (e.g., Mon/13, etc.) are gathered close to each other, and the time slots corresponding to weekend time periods from Friday evening to Sunday evening are also gathered close to each other. That is, by means of the RNN_LSTM based prediction model according to the invention, patterns occurring in the start times and registered times of the events registered in the calendar of the user may be observed, and thus a correlation may be found between the temporally or contextually close time slots, or a dominance relationship may be found between the temporally or contextually distant time slots.

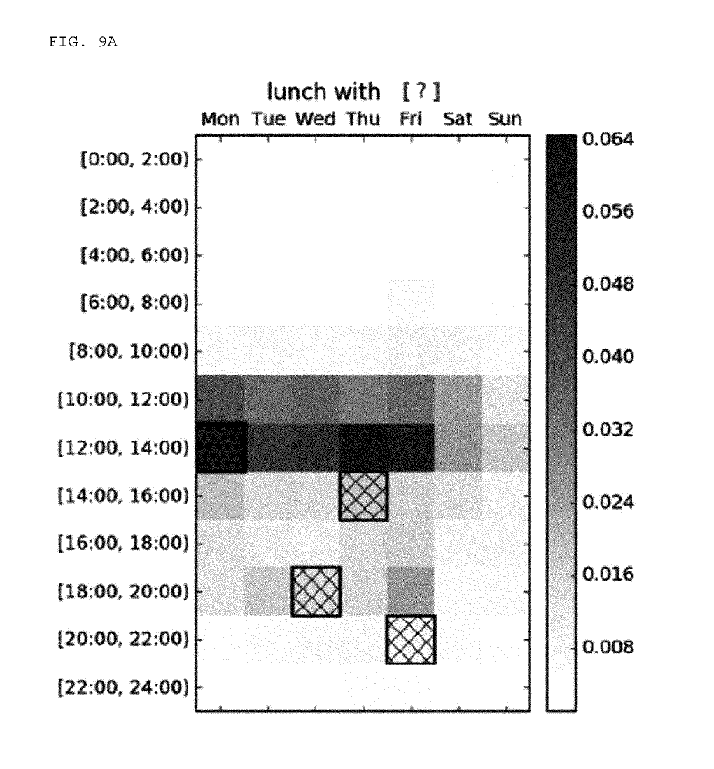

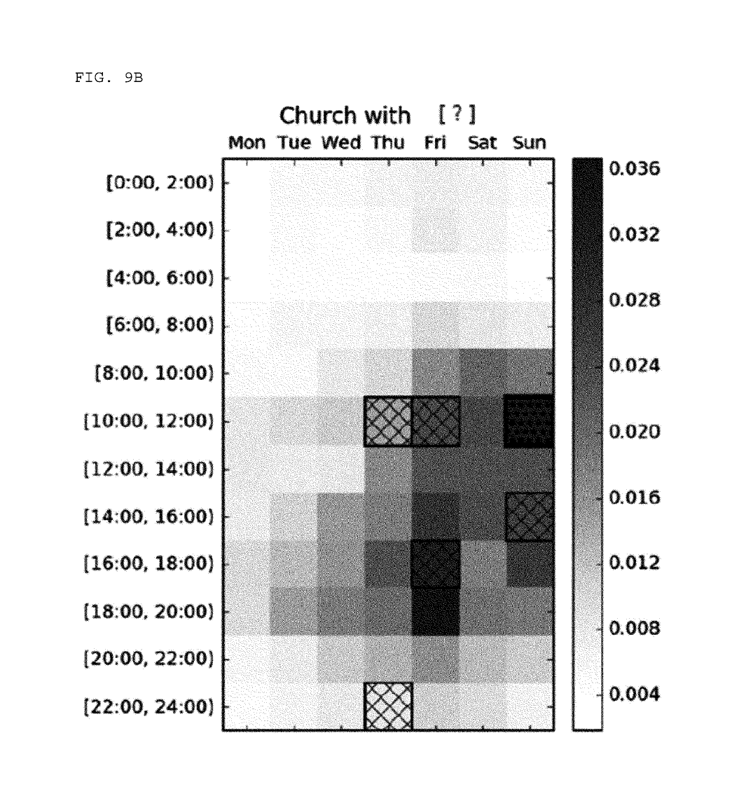

FIGS. 9A to 12B illustratively show a significant effect that may be achieved by referring to titles of events according to one embodiment of the invention.

In the test examples of FIGS. 9A to 12B, tests were conducted such that results of two tests with the same conditions except for texts included in a title of a new event were compared to indirectly examine the effects of the texts on the prediction of a start time of the new event. In FIGS. 9A to 12B, a time slot shown in a grid pattern indicates a time slot that includes a start time of an event already registered in a calendar of a target user, and a time slot shown in a dot pattern indicates a time slot that includes a start time of a new event newly registered in the calendar of the target user and is finally selected actually by the target user. Further, in FIGS. 9A to 12B, as a probability of the start time of the new event being included in a time slot is higher, the shade shown in the time slot is darker.

First, referring to FIGS. 9A and 9B, when a text of “lunch” is included in the title of the new event newly registered in the calendar of the user, it can be seen that a probability of the start time of the new event being included in the time slots corresponding to weekday lunch time (i.e., (10:00, 12:00) and (12:00, 14:00) on Mon, Tue, Wed, Thu, and Fri in FIG. 9A), which are deemed appropriate for lunch, was predicted to be high. When a text of “church” is included in the title of the new event, it can be seen that a probability of the start time of the new event being included in the time slots corresponding to weekend afternoon (i.e., afternoon on Fri, Sat, and Sun in FIG. 9B), which are deemed appropriate for going to church, was predicted to be high. That is, by means of the RNN_LSTM based prediction model according to the invention, the direct meanings of texts included in a title of a new event may be properly considered in predicting a start time of the new event.

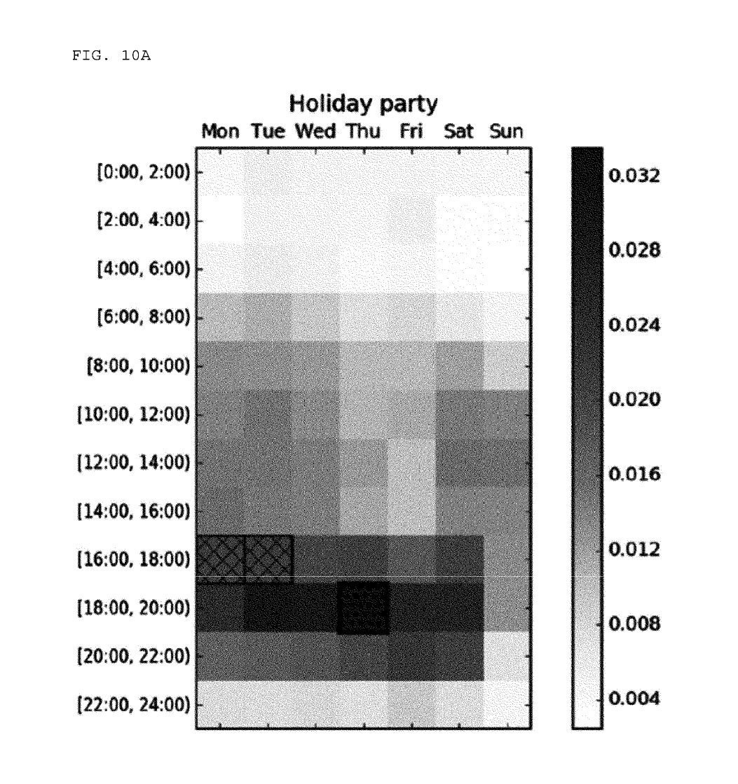

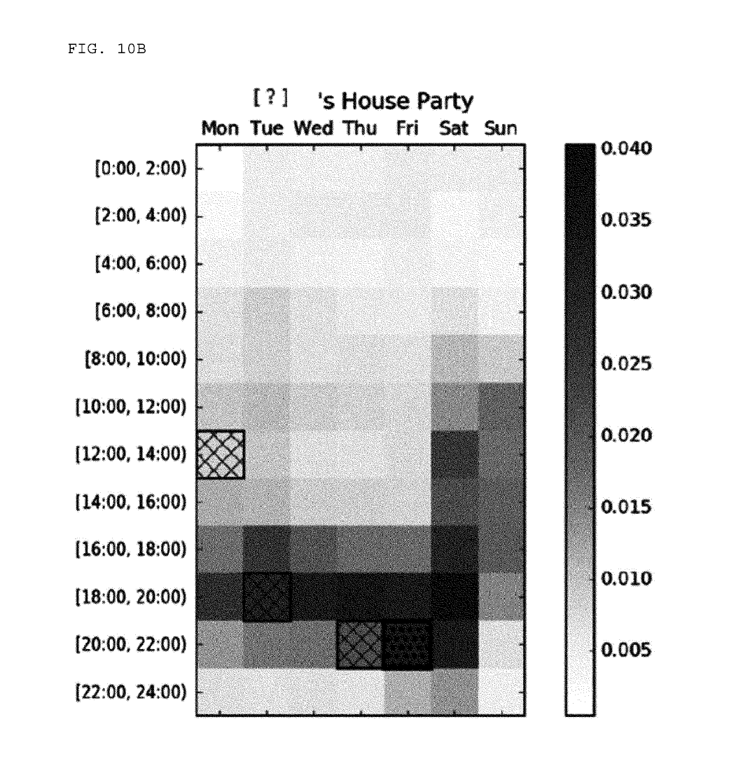

Next, referring to FIGS. 10A and 10B, when a text of “Holiday party” is included in the title of the new event newly registered in the calendar of the user, it can be seen that a probability of the start time of the new event being included in the time slots corresponding to weekday evening (i.e., (18:00, 20:00) on Mon, Tue, Wed, Thu, and Fri in FIG. 10A), which are deemed appropriate for holding a holiday party, was predicted to be high. When a text of “House party” is included in the title of the new event, it can be seen that a probability of the start time of the new event being included in the time slots corresponding to weekend evening (i.e., (18:00, 20:00) on Fri and Sat in FIG. 10B), which are deemed appropriate for holding a house party, was predicted to be high. That is, by means of the RNN_LSTM based prediction model according to the invention, the indirect meanings of texts included in a title of a new event may be properly considered in predicting a start time of the new event.

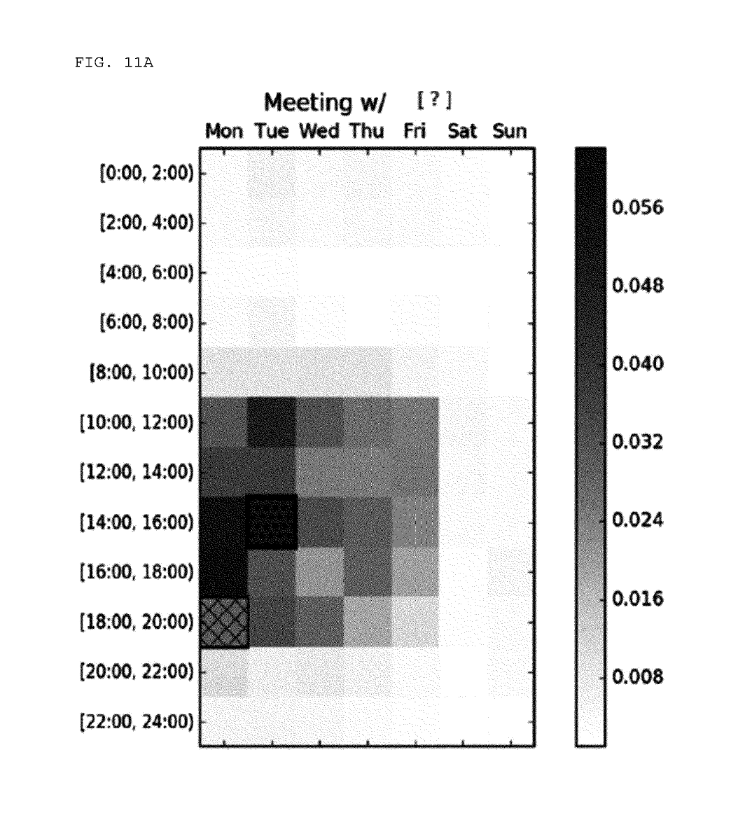

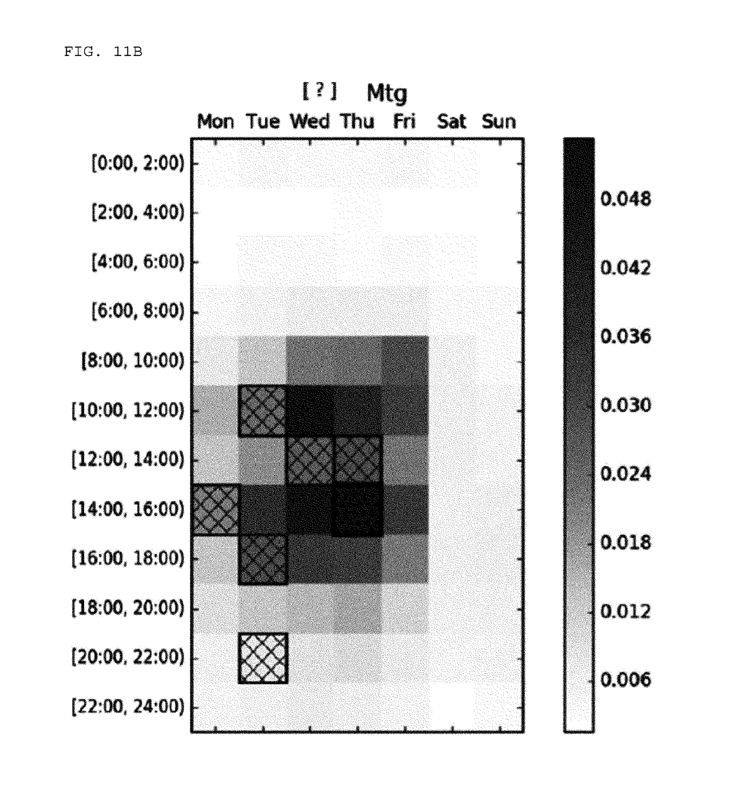

Next, referring to FIGS. 11A and 11B, when a text of “Meeting” is included in the title of the new event newly registered in the calendar of the user, and also when a text of “Mtg” is included in the title of the new event, it can be seen that a probability of the start time of the new event being included in the time slots corresponding to weekday forenoon or afternoon (i.e., (10:00, 12:00) to (16:00, 18:00) on Mon, Tue, Wed, Thu, and Fri in FIGS. 11A and 11B), which are deemed appropriate for holding a meeting, was predicted to be high. That is, by means of the RNN_LSTM based prediction model according to the invention, the meanings of abbreviations or symbols included in a title of a new event may be properly considered in predicting a start time of the new event.

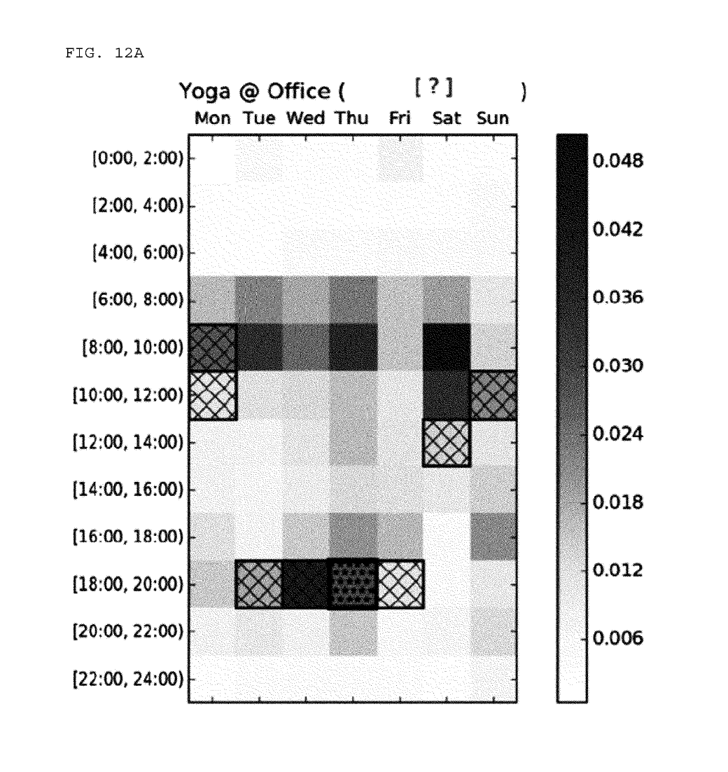

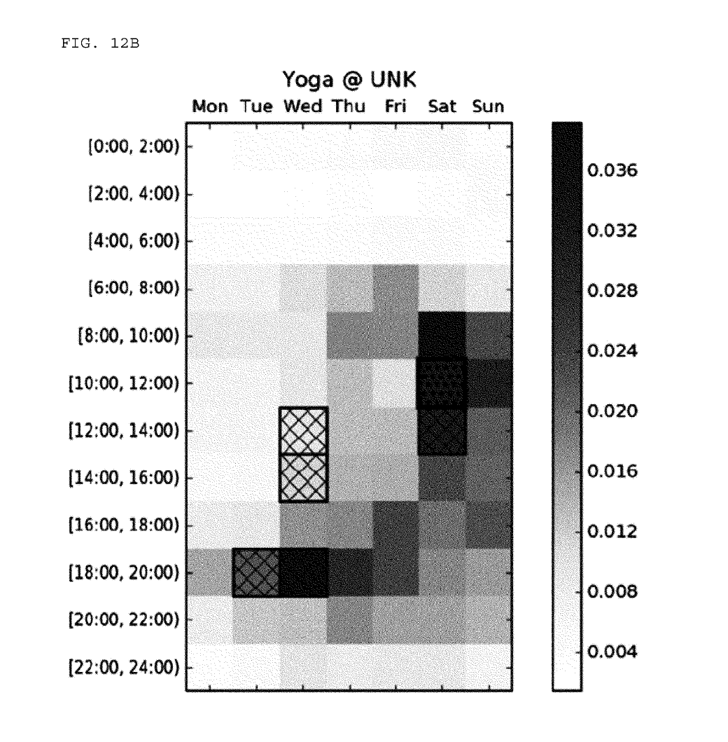

Next, referring to FIGS. 12A and 12B, when a text of “Yoga @ office” is included in the title of the new event newly registered in the calendar of the user, it can be seen that a probability of the start time of the new event being included in the time slots corresponding to weekday morning or evening (i.e., (08:00, 10:00) or (18:00, 20:00) on Mon, Tue, Wed, Thu, and Fri in FIG. 12A), which are deemed appropriate for practicing yoga near the office, was predicted to be high. When a text of “Yoga @ UNK” is included in the title of the new event, it can be seen that a probability of the start time of the new event being included in the time slots corresponding to weekday evening or weekend morning (i.e., (18:00, 20:00) on Mon, Tue, Wed, Thu, and Fri or (08:00, 10:00) on Sat and Sun in FIG. 12B), which are deemed appropriate for practicing yoga regardless of location, was predicted to be high. That is, according to the invention, the spatial meanings of texts included in a title of a new event may be properly considered in predicting a start time of the new event.

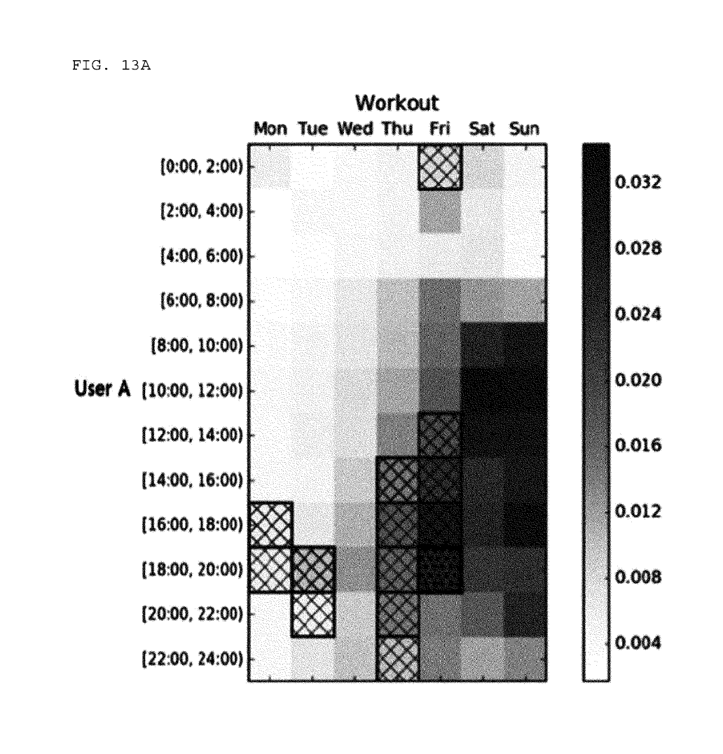

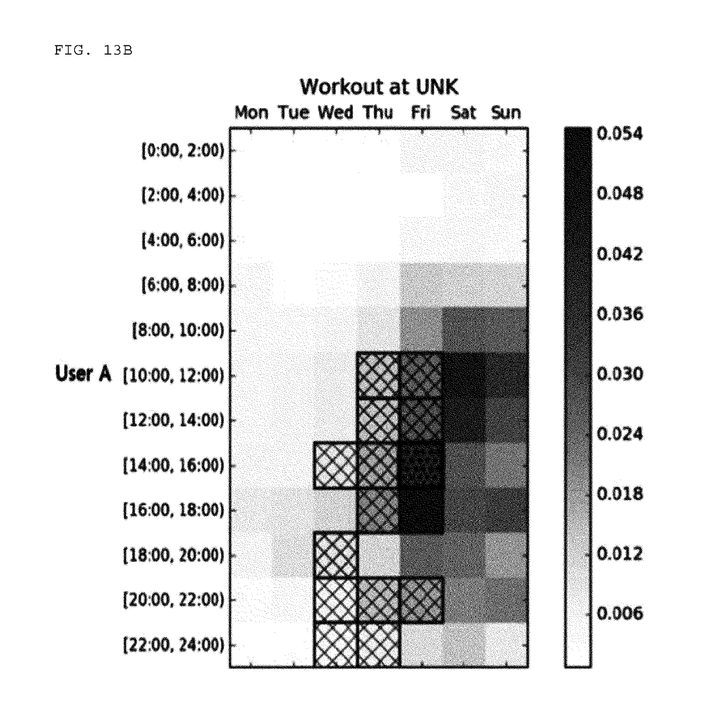

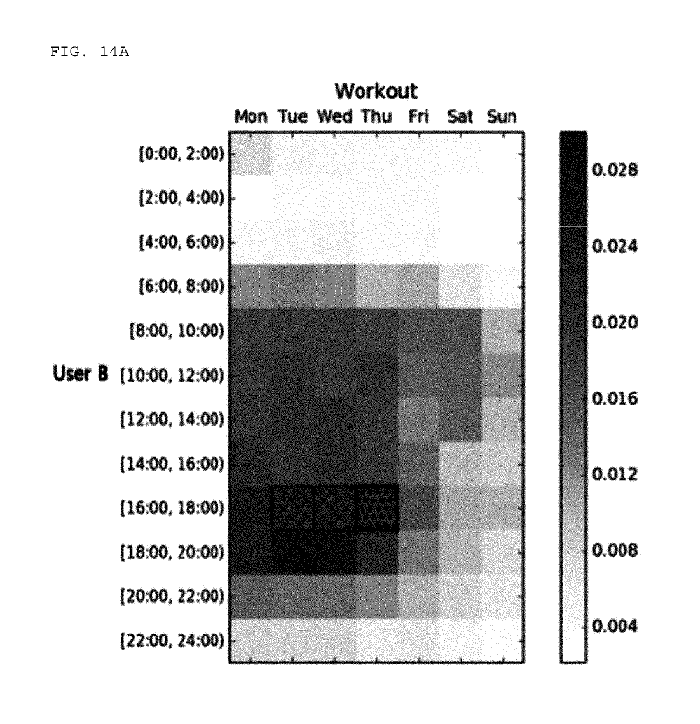

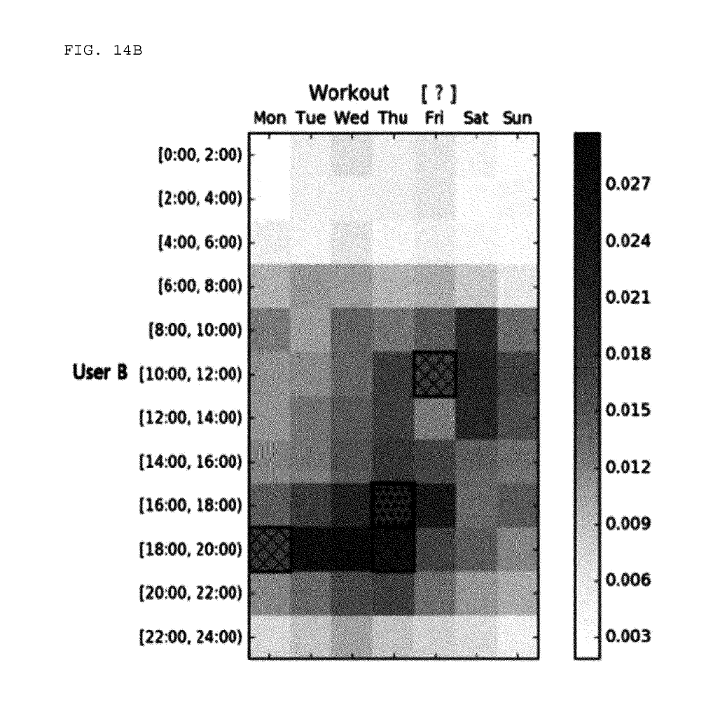

FIGS. 13A to 14B illustratively show a significant effect that may be achieved by referring to preference information of users according to one embodiment of the invention.

Referring to FIGS. 13A to 14B, when a text of “Workout” is included in a title of a new event to be newly registered in a calendar of a user A, it can be seen that a probability of a start time of the new event being included in the time slots corresponding to weekend afternoon was predicted to be high (see FIGS. 13A and 13B). However, when a text of “Workout” is also included in a title of a new event to be newly registered in a calendar of a user B, it can be seen that a probability of a start time of the new event being included in the time slots corresponding to weekday evening was predicted to be high, in contrast to the user A (see FIGS. 14A and 14B). That is, according to the invention, preference information of a target user may be properly considered in predicting a start time of a new event.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a prediction on a calendar, comprising the steps of:
generating first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user, generating second prediction data on the start time of the new event with reference to text information on the new event, and generating third prediction data on the start time of the new event with reference to preference information of the target user on the calendar; and
predicting the start time of the new event by calculating a likelihood of the start time of the new event being included in at least one time slot constituting the calendar of the target user, with reference to the first, second, and third prediction data.

2. The method of claim 1, wherein in the generating step, the first prediction data are generated by sequentially learning j−1^{th} calendar data, which include information on a start time of at least one event existing in a calendar of a m^{th} user immediately after a j−1^{th} event is registered in the calendar of the m^{th} user, and j^{th} calendar data, which include information on a start time of at least one event existing in the calendar of the m^{th} user immediately after a j^{th} event is registered in the calendar of the m^{th} user.

3. The method of claim 1, wherein in the generating step, the first prediction data are generated by sequentially learning the calendar data using a LSTM (Long Short Term Memory) based recurrent neural network algorithm.

4. The method of claim 1, wherein in the generating step, the calendar data are specified by a calendar map defined on the basis of at least one time slot constituting the calendar of the at least one user.

5. The method of claim 1, wherein in the generating step, the text information includes information on a text included in a title of the new event.

6. The method of claim 1, wherein in the generating step, the second prediction data are generated with reference to information on a relationship between the text information and time.

7. The method of claim 1, wherein in the generating step, the third prediction data are generated with reference to the preference information of the target user on at least one time slot constituting the calendar of the target user.

8. The method of claim 7, wherein the preference information of the target user on at least one time slot constituting the calendar of the target user is derived as a result of sequentially learning calendar data including information on start times of events existing in the calendar of the target user, in order of times at which the events are registered in the calendar of the target user.

9. The method of claim 1, wherein in the predicting step, the start time of the new event is predicted with reference to an output vector generated as a result of composition of a vector specifying the first prediction data, a vector specifying the second prediction data, and a vector specifying the third prediction data.

10. A non-transitory computer-readable recording medium having stored thereon a computer program for executing the method of claim 1.

11. A system for providing a prediction on a calendar, comprising:
a calendar data analysis unit configured to generate first prediction data on a start time of a new event to be newly registered in a calendar of a target user for which the prediction is to be made, by sequentially learning calendar data including information on a start time of at least one event existing in a calendar of at least one user, in order of time at which the at least one event is registered in the calendar of the at least one user;
a text information analysis unit configured to generate second prediction data on the start time of the new event with reference to text information on the new event;
a preference information analysis unit configured to generate third prediction data on the start time of the new event with reference to preference information of the target user on the calendar; and
a prediction provision unit configured to predict the start time of the new event by calculating a likelihood of the start time of the new event being included in at least one time slot constituting the calendar of the target user, with reference to the first, second, and third prediction data.

12. The system of claim 11, wherein the calendar data analysis unit is configured to generate the first prediction data by sequentially learning j−1^{th} calendar data, which include information on a start time of at least one event existing in a calendar of a m^{th} user immediately after a j−1^{th} event is registered in the calendar of the m^{th} user, and j^{th} calendar data, which include information on a start time of at least one event existing in the calendar of the m^{th} user immediately after a j^{th} event is registered in the calendar of the m^{th} user.

13. The system of claim 11, wherein the calendar data analysis unit is configured to generate the first prediction data by sequentially learning the calendar data using a LSTM (Long Short Term Memory) based recurrent neural network algorithm.

14. The system of claim 11, wherein the calendar data are specified by a calendar map defined on the basis of at least one time slot constituting the calendar of the at least one user.

15. The system of claim 11, wherein the text information includes information on a text included in a title of the new event.

16. The system of claim 11, wherein the text information analysis unit is configured to generate the second prediction data with reference to information on a relationship between the text information and time.

17. The system of claim 11, wherein the preference information analysis unit is configured to generate the third prediction data with reference to the preference information of the target user on at least one time slot constituting the calendar of the target user.

18. The system of claim 17, wherein the preference information of the target user on at least one time slot constituting the calendar of the target user is derived as a result of sequentially learning calendar data including information on start times of events existing in the calendar of the target user, in order of times at which the events are registered in the calendar of the target user.

19. The system of claim 11, wherein the prediction provision unit is configured to predict the start time of the new event with reference to an output vector generated as a result of composition of a vector specifying the first prediction data, a vector specifying the second prediction data, and a vector specifying the third prediction data.
